(19) United States
(12) Patent Application Publication
(10) Pub. No.: US 2019/0193298 A1
(43) Pub. Date: Jun. 27, 2019

(54) Set Of Glazed Brick Building Blocks

(71) Applicant: Takching Chan, Brooklyn, NY (US)

(72) Inventor: Takching Chan, Brooklyn, NY (US)

(21) Appl. No.: 16/293,107

(22) Filed: Mar. 5, 2019

Related U.S. Application Data
(63) Continuation of application No. 15/410,053, filed on Apr. 13, 2017, now abandoned.

(51) Int. Cl. B28B 11/04; E04C 1/41

(52) U.S. Cl. CPC B28B 11/044; C04B 33/34; E04C 1/41

(57) ABSTRACT

A set of hollow clay-brick blocks having rectangular dimensional sizes of 23″×12″×23″, 23″×12″×12″, 23″×12″×10″, 11.5″×12″×10.5″, 23″×12″×11″ or 23″×12″×11″, and each brick block has at least one of exterior side that is ceramiclly glazed.

### CROSS-REFERENCES

This application claims the priority of the U.S. patent application Ser. No. 15/410,053 filed on Feb. 13, 2017, the entirety of which is thereby incorporated by reference.

### DESCRIPTION OF RELATED ART

The present application relates to a set of glazed brick blocks, and more particularly to a set of glazed brick blocks specifically designed for efficiently setting up and construction an entire community with various constructions, such as, apartment buildings, roads, schools, and hospitals etc.

Note that the points discussed below may reflect the hindsight gained from the disclosed inventions, and are not necessarily admitted to be prior art.

Since 1901 the invention of ventilated and hollow bricks, we have seen various hollow brick blocks being used in constructions. Wall bricks include fired bricks and non-fired bricks. According to different manufacturing techniques, fired bricks include fired common bricks, fired porous bricks, fired hollow bricks and hollow blocks (simply called hollow bricks); and non-fired bricks include autoclaved lime-sand bricks, fly ash bricks, slag bricks, and carbonated lime bricks. A fired brick is made by preheating, roasting, insulating and cooling a raw brick in a kiln. A fired common brick is a common solid brick made by roasting clay, shale, coal gangue or fly ash. The fired common brick is usually rectangular, and its standard size is small-sized and the major one is 390 mm×190 mm×190 mm. The compressive strength of blocks is obtained by the gross area of the compressed face dividing broken loads, fired common brick compressive strength can be divided into MU3.5˜MU20.0.

Hollow brick blocks are also called Masonry bricks composed of fired-clay bricks (solid or perforated) or blocks (concrete or earth-based). With the rise of reinforced concrete flooring and metal decking, structural clay tile fell out of popularity in flooring and roofing, but remains its use in walls. Wall tile blocks continue to be manufactured, but specialty tile units often require custom commissions. See M. Bruggi, A. Taliercio, “Eco-efficient Masonry Bricks and Blocks”, 2015 Woodhead Publishing.

Now Over 99% of multi-story structures are of reinforced concrete framing. Steel and brick structures only account for less than 1%. Of the reinforced concrete structures, 75% use hollow clay blocks reinforced concrete slabs. Designs of single slab panel two story reinforced concrete structures with one side having a constant dimension of 8 m while the dimension is varied from 2 m, 3 m, 4 m, 5 m, 6 m, 7 m up to 8 m were carried out for both solid and hollow clay blocks slabs construction. Many researches have been conducted for hollow concrete blocks on the design loads, moments, reinforcement, shear stresses and costs for each case of solid and hollow blocks slabs. It was found that contrary to common beliefs, solid (solid or perforated) or blocks (concrete or earth-based) slabs are cheaper than hollow clay blocks slabs in construction because hollow clay blocks need a minimum topping of 50 mm (1.96 inches), and are manufactured in standard sizes of 125 mm (4.9 inches), 150 mm (5.9 inches), 175 mm (6.8 inches), 200 mm (7.87 inches) and 225 mm (8.85 inches). This implies that for spans of about 2 m, solid slabs can be 75 mm, 100 mm thick, while the minimum thickness of hollow blocks is 175 mm. Also unlike solid slabs, for hollow clay blocks slab over 6 m long, shear reinforcement may be needed, and as the length increases to 8 m, the topping for hollow blocks increases to an uneconomic value.

However for large structures with over two stories, hollow blocks slab construction might be cheaper as the reduced weight leads to smaller columns and foundations. Furthermore hollow block slabs are easier to detail, construct and are less prone to errors on site. And for hollow blocks slabs less than 4 m span, the design load is constant because the slab thickness used is dictated by topping requirements and depth of available blocks. Despite the fact that the solid slab has a greater load and thus greater applied moment it has a greater reserve capacity, its ratio of applied to ultimate moments is less than that of hollow blocks for all spans greater than 3 m. Also its areas of reinforcement in mm² per m width of slab are less than that for hollow blocks slab for all spans. Because the value of applied shear stress v and concrete shear stress v_{c} obtained depends on the value of bᵥ (the breadth of the section for shear resistance) used, the usual practice is to stop hollow blocks at about 500 mm to 1000 mm from the support and for this length the slab is made solid. This serves to increase the shear resistance of slab close to the support. But hollow blocks provide additional benefit for good thermal and acoustic insulation, due to the air existing in their gaps.

The disadvantages of traditional solid bricks stem from the low thermal comfort, the high construction costs and the lengthy building interval. Traditional brick sizes have been maintained at various almost standard sizes, for example (L×H×W in mm): 40×290×238; 460×200×238; 120×290×238; 290×140×238; 290×240×138; 290×240×188; 300×240×238; 375×240×238; 375×140×188; 375×140×238; 240×115×138; 250×380×188; 290×240×188; 365×180×188; 365×180×138; 290×240×138; 290×240×138; 290×140×188; 365×115×188. They are too small to be used for efficient construction, and large buildings. It is used for making exterior load-bearing and non-load-bearing walls, as well as separating walls in buildings, both load-bearing and non-structural. Since 99% constructions have been using reinforced concrete blocks, not much improvement has been developed for clay bricks.

It is particular useful if a set of particularly sized hollow clay brick blocks can be made that can withstand as much shear stress as a concrete block and can also easily satisfy the regulations, as this will greatly reduce the cost of construction and improve construction efficiency, because of the availability of clay material. There is a need for such set of clay brick blocks.

### SUMMARY

The present application discloses a set of new clay brick blocks that significantly improves cost and efficiency in construction higher buildings.

In one aspect of this application, a set of hollow clay brick blocks are provided with a set of rectangular hollow blocks with L×H×W dimensions of 23″×12″×23″, 23″×12″×12″, 23″×12″×10″, 11.5″×12″×10.5″, 23″×12″×11″, 23″×12″×11″ and a trapezoidal hollow block with trapezoid one side of L×H×W dimension 23″×12″×23″ and the other side of 21″×12″×23″ and a trapezoidal hollow brick block with trapezoid one side of L×H×W dimension 22″×12″×23″ and the other side of 23″×12″×23″.

In one aspect of this application, each of the hollow clay brick blocks comprises two adjacent hollow blocks separated with a middle supporting wall of at least 3″-4″ thickness, and the surrounding walls of at least 2″ thickness.

In one aspect of this application, each of the hollow clay brick blocks is glazed at one to three exterior sides with ceramics and styles. The disclosed innovation, in various embodiments, provides a set of ready to use fired hollow clay-brick construction blocks that allow the enhancement of I-shaped steel and iron for columns building and for building high story buildings with efficiency without the need for further exterior tiling. Among the advantages of brick blocks, they are proficient thermal and acoustic insulation, structure stability, seismic protection, mechanical strength superior to other materials such as autoclaved aerated concrete, fire proof for being non-flammable products, long lifespan, and 100% natural products. They are also suitable for masonry building process which affords more artistic and customary building designs.

### BRIEF DESCRIPTION OF THE DRAWINGS

The disclosed application will be described with reference to the accompanying drawings, which show important sample embodiments of the invention and which are incorporated in the specification hereof by reference, wherein:

FIGS. 1 and 2 show perspective views of an example hollow clay brick block with glazed sides in accordance with this application.

FIGS. 3, 4, 5A and 5B show perspective views of an example hollow clay brick block with glazed sides in accordance with this application.

FIGS. 6-14 show plan views of an example set of hollow clay brick blocks for modular-style efficient construction.

FIG. 15 shows a plan view of different arrangements of the brick blocks in constructing structural elements in accordance with this application.

FIGS. 16-25 show several example ways of structural assemblies in construction using the set of hollow clay brick blocks of FIGS. 6-14, demonstrating improved efficiency for construction.

FIG. 26 shows an example building design built by the sized clay-blocks in accordance with this application.

### DETAILED DESCRIPTION OF SAMPLE EMBODIMENTS

The numerous innovative teachings of the present application will be described with particular reference to presently preferred embodiments (by way of example, and not of limitation). The present application describes several embodiments, and none of the statements below should be taken as limiting the claims generally.

For simplicity and clarity of illustration, the drawing figures illustrate the general manner of construction, and description and details of well-known features and techniques may be omitted to avoid unnecessarily obscuring the invention. Additionally, elements in the drawing figures are not necessarily drawn to scale, some areas or elements may be expanded to help improve understanding of embodiments of the invention.

The terms “first,” “second,” “third,” “fourth,” and the like in the description and the claims, if any, may be used for distinguishing between similar elements and not necessarily for describing a particular sequential or chronological order. It is to be understood that the terms so used are interchangeable. Furthermore, the terms “comprise,” “include,” “have,” and any variations thereof, are intended to cover non-exclusive inclusions, such that a process, method, article, apparatus, or composition that comprises a list of elements is not necessarily limited to those elements, but may include other elements not expressly listed or inherent to such process, method, article, apparatus, or composition.

It is contemplated and intended that the design apply to various materials suitable for being construction material; for clarity reason, the examples are given based on fired hollow clay bricks, but an ordinary person in the art would know the variations to modify the design to provide various other sizes and dimensions.

Masonry building is the oldest and most common method in construction, it is the process by which different blocks are placed one above and/or next to each other. A binder is commonly used, mostly mortar based on cement and lime. For example, masonry has been used to raise pyramids, Roman aqueducts, bridges, it still remains a reliable method today.

In masonry structures the armed elements are very important as they support and counteract the horizontal and vertical forces that occur after a major sudden earthquake. The pillars and the belts, the vertical and the horizontal elements, are linked together so as to compose a single and unified corpus. They all are concrete elements that transfer the energy coming from the tectonic movement through the reinforcing steel. Therefore it is usually regulated that the maximum length of the side of a wall between two reinforced pillars should not exceed 5 meters (16.4 feet). Link joints are used in the construction of masonry in order to ensure the monolith content of the full brick masonry. Mortar as binding material are used to bind the joints together. The mortars in construction are usually well mixed compositions of binder, water and fine aggregate with additives such as: plasticizers, pigments, water proof substances, substances for adjusting the setting, hydraulic active substances, etc. Ordinary mortars are based on lime, cement, plaster, clay earth. Their compressive strength may be for example: M4, M10, M25, M50, M100 (figures indicating minimum compressive strength at 28 days, in daN/cm²). For mortar M4, the compressive strength is determined at 90 days and it must be of 49 daN/cm².

The clay bricks are usually made from a mixture of clay, sand and water or of other materials such as concrete, blast furnace slag etc., sun-dried or burned in a furnace. The initial step in producing brick is crushing and grinding the raw materials in a separator and a jaw crusher. Next, the blend of ingredients desired for each particular batch is selected and filtered before being sent on to one of three brick shaping processes such as extrusion, molding, or pressing. Once the desired bricks are formed and any glaze processes are performed, they are dried to remove excess moisture that might otherwise cause cracking during the ensuing firing process. Next, they are fired in ovens and then cooled.

In comparison, concrete, or autoclaved aerated concrete, is obtained from a mixture of sand, cement, lime, gypsum, water. For porous structure, a reaction between the aluminum powder and an acid is induced, and further it is subjected to autoclaving with high temperature, high pressure steam, which cause the release of silica and quartz. The concrete blocks undergo a curing process and then are cut (trimmed) in blocks of different shapes and sizes depending on their subsequent use.

The compressive strength Rc is the tension (σc) to which a material breaks after being subjected to compression. Compressive strength is usually measured in laboratories. Higher compressive strength means higher bearing capacity. The bulk density (ρa) is the ratio between the mass of a subject and its apparent volume, which includes pores, cracks and any internal empty spaces. Lower bulk density for bricks means a larger volume of empty spaces or pores, hence better thermal insulation. Moreover, the lower the apparent density, the lower the loads on the structural system, which, in its turn, will lead to structural elements with smaller sections and lower reinforcing steel consumption. It is well known that the seismic force a building bears during an earthquake is commensurate with the mass of that building, so it would be ideal to construct buildings which are as light as possible, while meeting all the standards of safety and comfort.

If the structural system of the building is on frames, such as, boards, beams and columns that take all forces exerted on the building, or on concrete structural walls, the compressive strength of the construction material becomes irrelevant, since they do not serve as structural element. The only load they take is their own weight and the finishing. The thermal conductivity (λ) is the property of materials to transmit via their mass the heat flux produced by the temperature difference between two opposite sides. For homogeneous flat wall with parallel faces, by thickness (d) and surface (S) when there is a difference of temperature (t1−t2) between the opposite faces, λ=(Q*d)/[S*(t1−t2)*τ] where (τ) is the time interval for heat flux. Construction materials with λ<0.29 are conventionally considered as thermal insulators. Thermal insulation properties are also assessed by the thermal resistance (R), computed by the formula R=1/λ. The lower the thermal conductivity of a material is, the higher the thermal resistance of that material will be, so it insulates better. It means lower heat loss through a high thermal resistance wall, hence energy consumption for heating the building will decrease. The reaction to fire is the property of materials to temporarily withstand high temperatures (circa 1000° C., as they occur in fires), without damage. Clay bricks have a compression strength 17-22 N/mm² which is much higher than that of concrete blocks (1-4 N/mm²), clay bricks also have higher bulk density (600-1600 kg/m³) than that of concrete blocks (500-700 kg/m³). Fired bricks are more fire resistance because they are manufactured through burning in high temperature furnace (called kilns). Bricks are more heat conductive (>0.18 W/mK) while aerated concrete blocks are less heat conductive (0.13-0.19 W/mK).

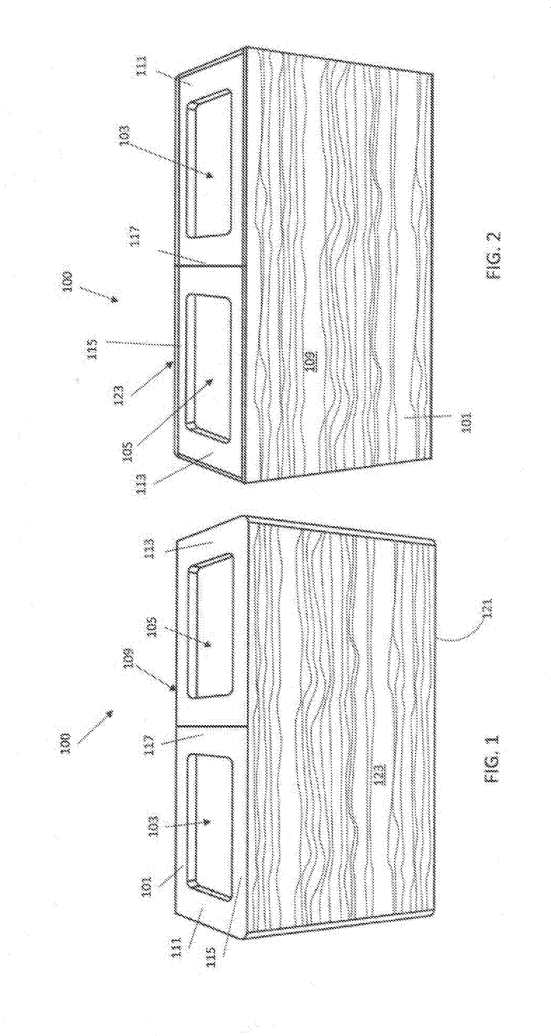

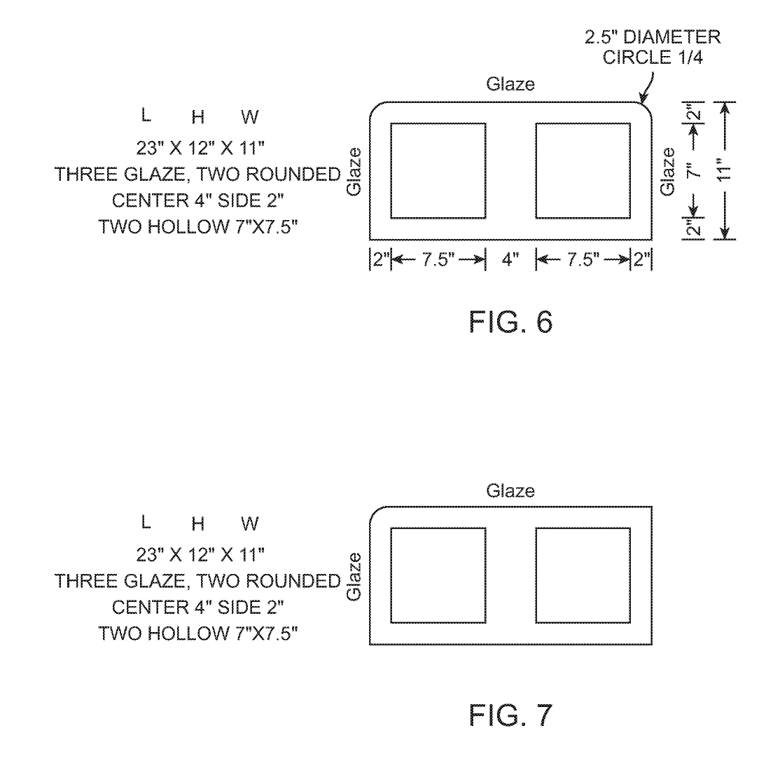

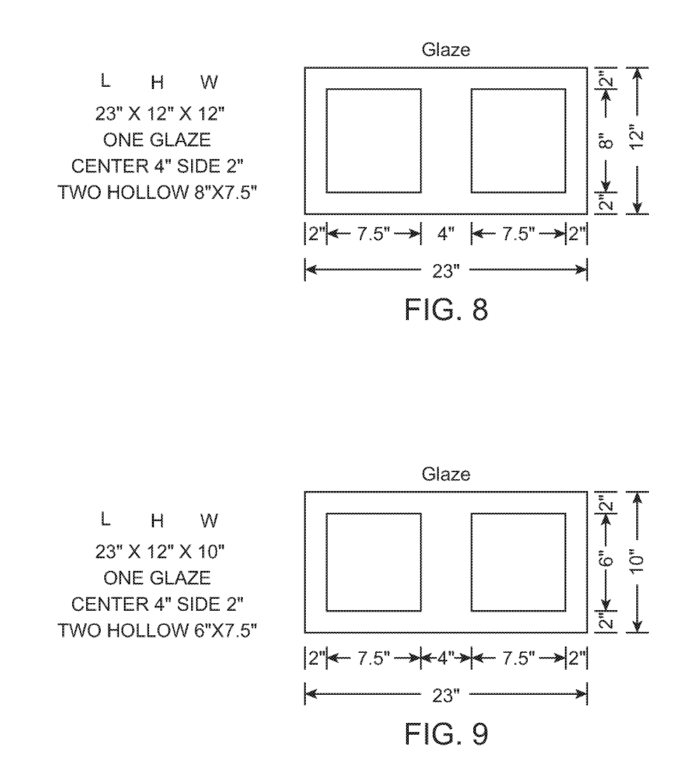

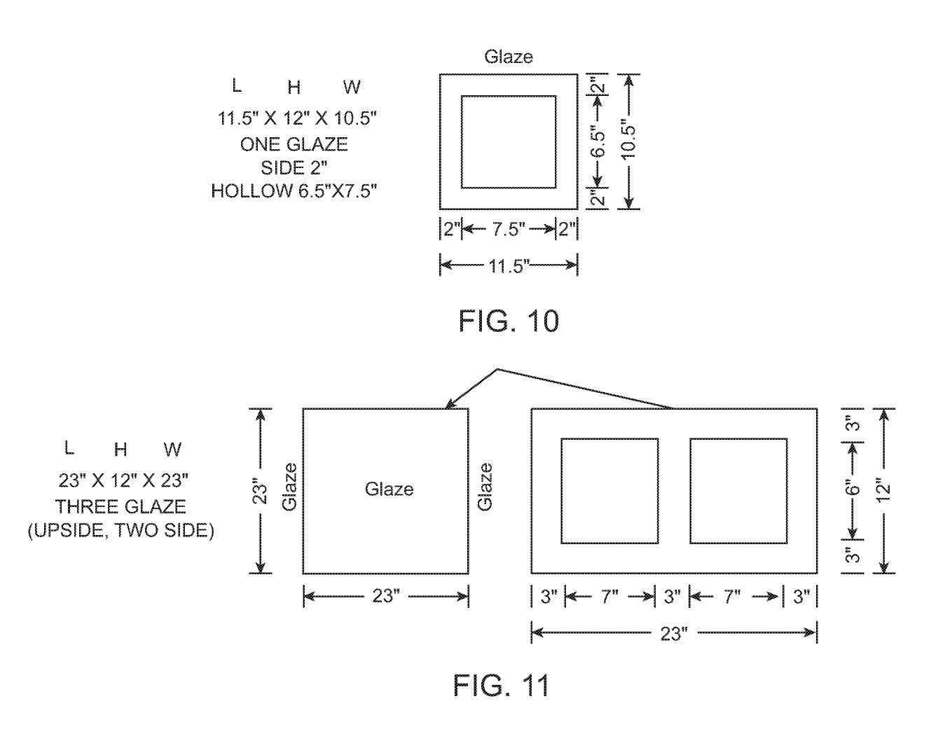

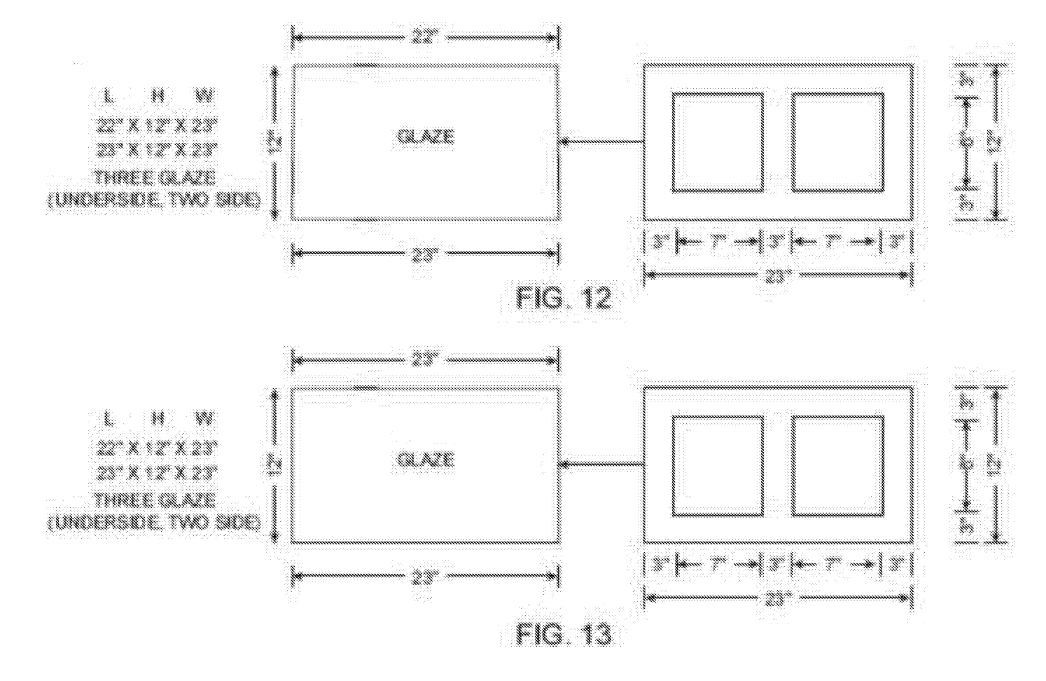

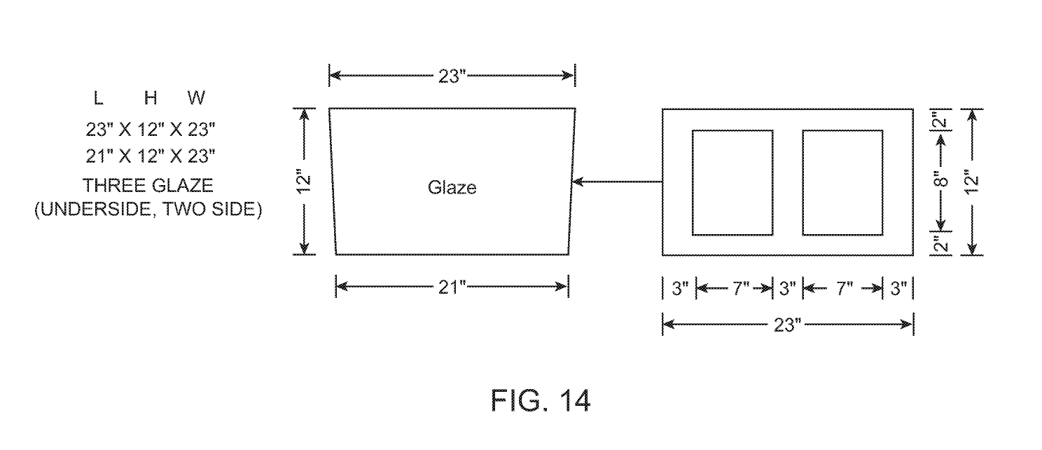

Therefore to improve the thermal resistance, brick blocks are designed with hollow spaces. In addition, one or more sides of a brick block are glazed with ceramics to improve construction efficiency. In reference to FIG. 1-5A and 5B, a clay brick block 100 is designed rectangular in shape with two adjacent rectangular/cubic hollow spaces 103 and 105. These two hollow spaces 103 and 105 are separated with a middle wall 117 of 4 inch thickness. Hollow spaces 103 and 105 preferably are of a length of 6.5-7.5 inches, height of 12 inches and width of 11-12 inches. They are formed by walls 101, 111, 113, 115 and 117 which form a rectangular brick block with dimensions of 23″×12″×12″. Clay walls 101, 111, 113 and 115 have a thickness of at least 2 inches. The dimension of brick block 100 is preferably a rectangular with L×H×W dimension of 23″×12″×11″ (FIG. 6, 7), 23″×12″×12″ (FIG. 8), 23″×12″×10″ (FIG. 9), or 11.5″×12″×10.5″ (FIG. 10). The sizes are particularly designed so that two blocks of FIG. 8 can form a square block of 2 can form a square 23″×12″×23″ (FIG. 11) that can be used for the wall supporting a window structure of multiples of 4 feet. It can also be shaped as a trapezoidal hollow block with one trapezoid side of L×H×W dimension 23″×12″×23″ and the other trapezoid side of 21″×12″×23″ (FIG. 14) or as a trapezoidal hollow brick block with one trapezoid side of L×H×W dimension 22″×12″×23″ and the other trapezoid side of 23″×12″×23″ (FIG. 12). Alternatively, brick block 100 is made in parallelogram shape with both top 125 and bottom 121 parallel sides with L×H×W dimension 23″×12″×23″ (FIG. 13). These sizes have never been developed because concrete blocks in combination of a layer of exterior small sized bricks have been dominantly used in construction.

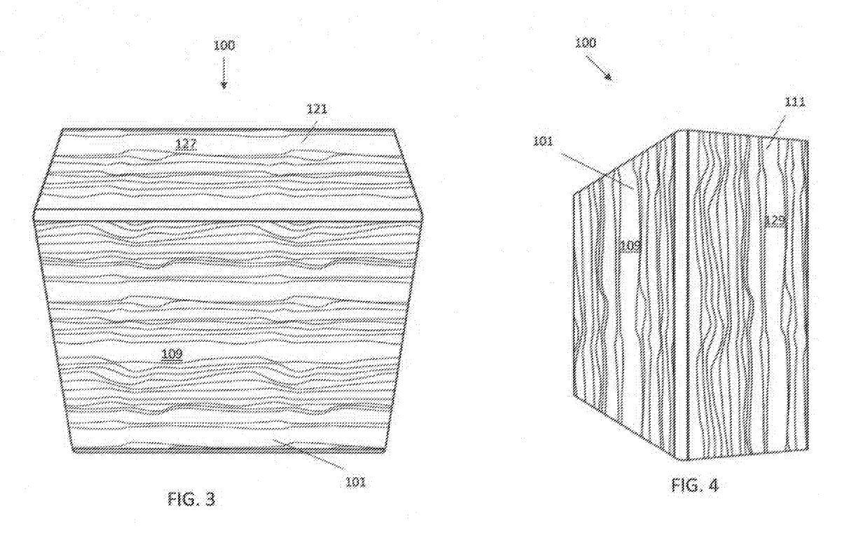

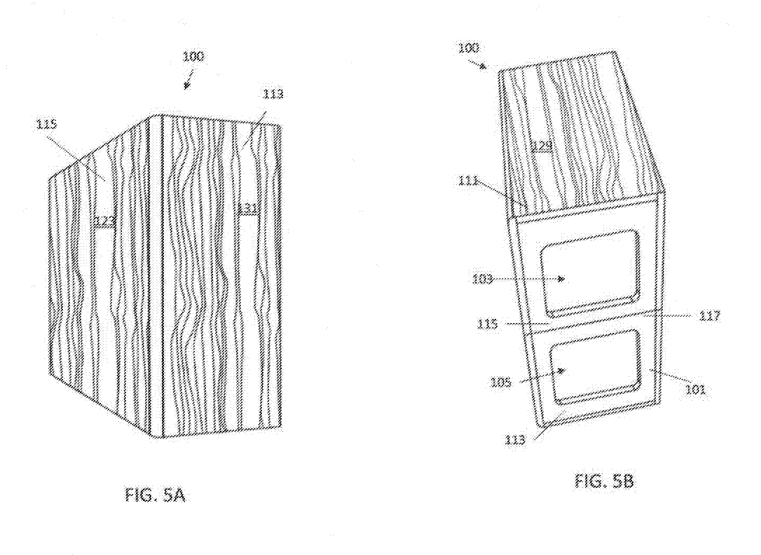

As shown in FIG. 1-5A and 5B, brick block 100 is also glazed on 2-3 sides of the block, such as, on exterior surface 123 of wall 115 (FIG. 1), exterior surface 109 of wall 101 (FIG. 2), on exterior surface 127 of bottom side 121 (FIG. 3), on exterior surface 131 of side wall 113 (FIG. 5A) or on exterior surface 129 of side wall 111 (FIG. 5B). Glazes are great both for decorating and for creating an attractive glossy surface that protects the wall from wear and water. Molded brick blocks first go through a “bisque” firing process to make it hard and to have porous absorbent surface, then spray wet glaze mixture made out of dry powdered commercially available glaze chemicals that contain silica, alumina, various ground elements, and water. Then firing the glazed brick blocks in at the required temperatures in the kiln. The glazed brick blocks eliminate the need to further exterior and interior decoration and protection and painting. The brick blocks can be glazed at all sides except the top side of hollow space, or two to three sides depending the use of the brick. The brick block of FIG. 6 has two rounded edges for forming ends of columns or walls, it is glazed on three sides. The brick block of FIG. 7 has one rounded edge for forming one end of a wall with other adjacent brick blocks is glazed on two sides. The brick block of FIG. 8 has no rounded edge for forming the middle section of a wall, is glazed at one side. The brick blocks of FIGS. 9 and 10 are for forming corners of a building, are glazed at one side. The brick blocks of FIGS. 11, 12, 13, and 14 are for construction of the windows, are glazed on three sides including the underside. Two three side glazed brick blocks of FIG. 11 can be used to form the 23×12×23 square column for supporting a window. The trapezoid brick block of FIG. 12 is used for the upper side of a window, and the trapezoid brick block of FIG. 14 is used for the lower side of a window. They can efficiently build window sizes of 48 feet long×12 feet high or 8 feet 9 inches high and 4 feet wide by stacking together several layers bricks together through masonry building process. For windows the wall will have a 23 inch thickness with two layer of bricks forming a square (FIG. 11). The glazing compound of brick blocks is cured and heat-treated in gas-fired tunnel kilns, thus becoming an integral part of the masonry brick block unit. The glazed brick masonry units are molded in individual molds, ensuring dimensional uniformity of the glazed facing regardless of minor variations in the blocks.

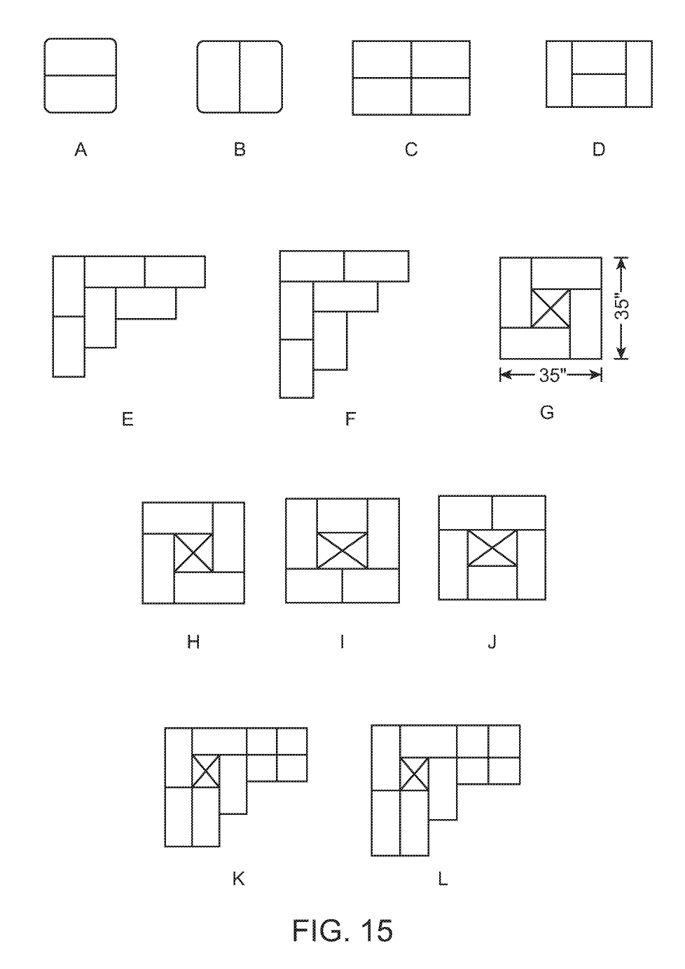

From the viewpoint of the loads they take, walls are divided into 2 categories: structure walls that take horizontal and vertical loads as well as bending moments and non-structure walls that take only the loads of their own weight and any loads perpendicular to their plane that may appear accidentally. Masonry is started from corners or from an empty space such as a doorway or window, the first and last brick rows are made of bricks laid crosswise. Mortar is not laid on the last row. Before work, bricks get wet with water; mortar composition is given in the project and its consistency is determined by the standard cone. In the present application, the minimum thickness of load-bearing walls is 1 brick block, one-brick walls are 23 inch thick. The length of 23 inch is necessary so that there is a half inch gap at each end for laying mortar, and making each brick block a length of 24 inches, a size each to standardize and to plan. In performing masonry, particular attention must be paid to wall verticality and flatness. The placement of the bricks is so that each row is offset from the previous by exactly half a brick, thus avoiding the situation where two joints overlap vertically. That is what the brick blocks of FIGS. 9 and 10 are for. The various arrangements of the glazed brick blocks are shown in FIG. 15, for corners (FIG. 15A-15F) and for various column sizes of hollow columns (FIG. 15G, 15H, 15K and 15L) which have a 13″×13″ center hollow space that can install an I-steel beam inside to provide structural frame support of the building. For beams and structural walls, these elements take the vertical and lateral loads that may occur throughout the life of the building, I-steel beam will need to be used especially in tall buildings where earthquake loads and gravitational forces are very strong. Masonry walls with I-steel beam and/or reinforced concrete seeds are used at the intersections of walls, columns and perimeter belts on top of the spalet masonry. The reinforced concrete belts are poured together with the reinforced concrete slab over the previously made spalet (with pillars). To provide larger supporting columns, longer brick blocks can be made with size of L26″×H12″×W11″ which can form 38″×38″ column with center hollow 16″×16″; or size of L30″×H12″×W11″ which can form 42″×42″ column with center hollow 20″×20″.

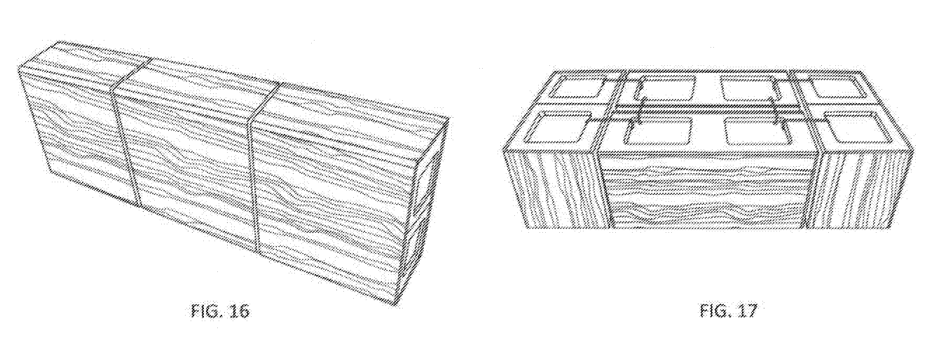

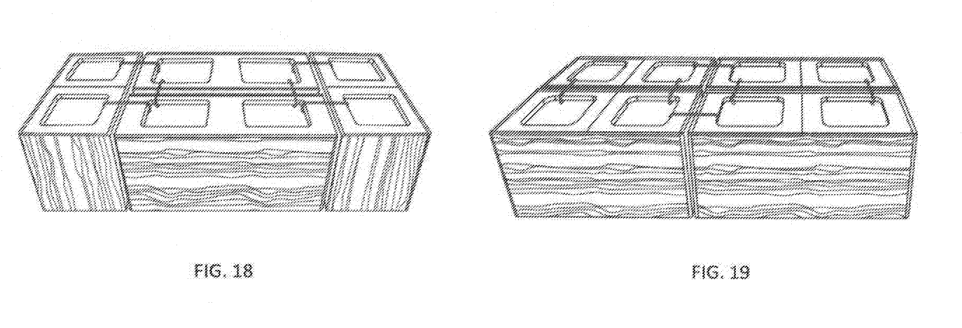

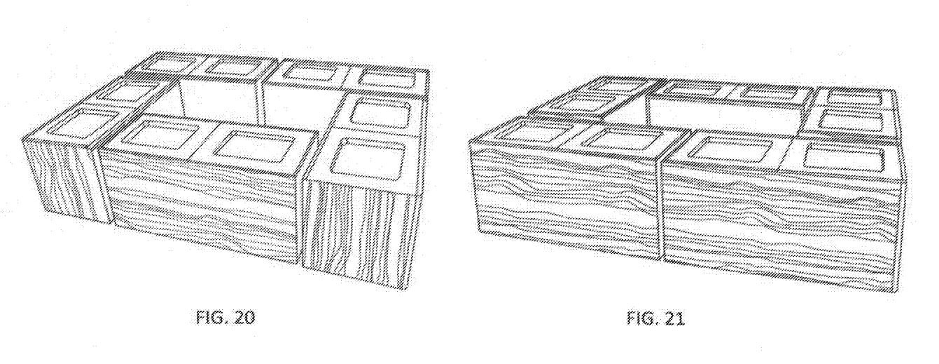

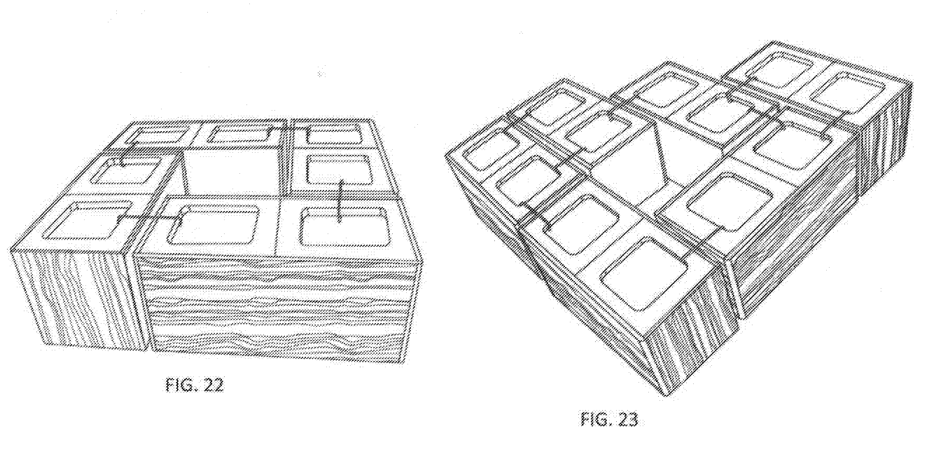

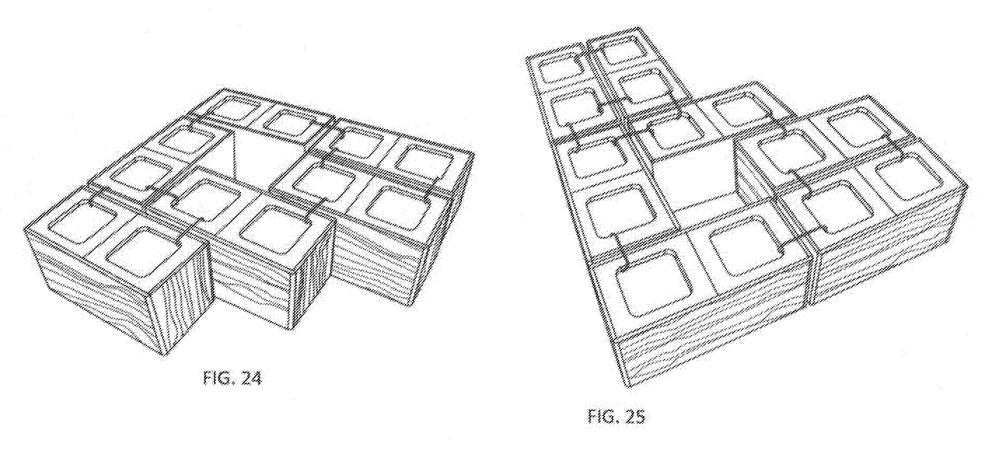

FIGS. 16-25 illustrate the various arrangement and combinations to form a ready to use wall, or a hollow column, or a corner structure.

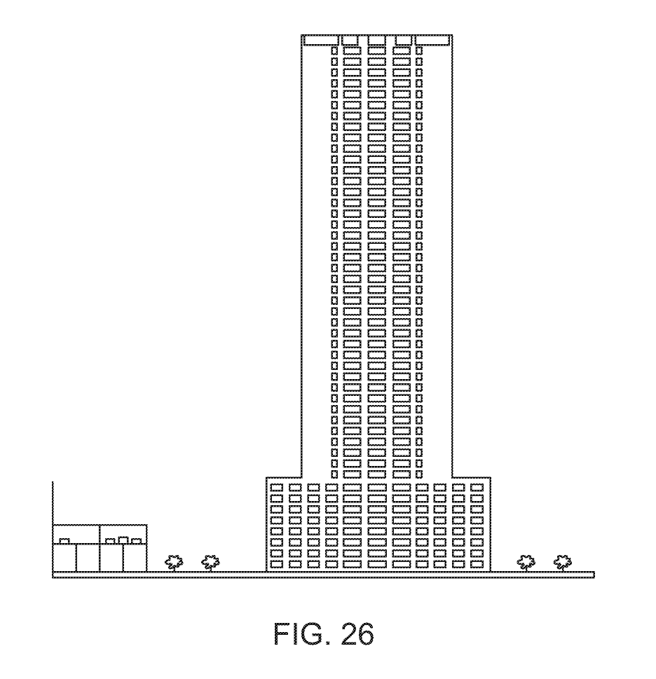

Such sized clay blocks can improve construction efficiency, and quickly build buildings with standard sizes as shown in FIG. 26.

As will be recognized by those skilled in the art, the innovative concepts described in the present application can be modified and varied over a tremendous range of applications, and accordingly the scope of patented subject matter is not limited by any of the specific exemplary teachings given. It is intended to embrace all such alternatives, modifications and variations that fall within the spirit and broad scope of the appended claims.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC section 112 unless the exact words “means for” are followed by a participle. The claims as filed are intended to be as comprehensive as possible, and NO subject matter is intentionally relinquished, dedicated, or abandoned.

What is claimed is:

1. A set of glazed clay-brick blocks, comprising:
at least one rectangular hollow clay-brick block having a L×H×W dimension of 23″×12″×12″, said hollow clay-brick block having two-rectangular hollow spaces separated in-between by a 4″ thickness wall, the two-rectangular hollow spaces are surrounded by walls of at least 2″ thickness; and
at least one exterior surface side of said hollow clay-brick block is glazed with ceramic compound and is water-proof;
wherein said hollow clay-brick block is made of clay.

2. A set of glazed clay-brick blocks, comprising:
A set of rectangular hollow clay-brick blocks, respectively having a L×H×W dimension of 23″×12″×23″, 23″×12″×12″, 23″×12″×10″, 11.5″×12″×10.5″, 23″×12″×11″ or 23″×12″×11″; each of said hollow clay-brick blocks having two-rectangular hollow spaces separated in-between by a 4″thickness wall, the two-rectangular hollow spaces are surrounded by walls of at least 2″ thickness, except the brick block of 11.5″×12″×10.5″ having one rectangular hollow space surrounded by walls of at least 2″ thickness; and
at least one exterior surface side of said set of hollow clay-brick blocks is glazed with ceramic compound and is water-proof;
wherein each of said set of hollow clay-brick blocks is made of clay.

3. The set of glazed clay-brick blocks of claim 2, further comprising:
a trapezoidal hollow clay-brick block with one trapezoid side of L×H×W dimension 23″×12″×23″ and the other trapezoid side of 21″×12″×23″;
a trapezoidal hollow brick block with one trapezoid side of L×H×W dimension 22″×12″×23″ and the other trapezoid side of 23″×12″×23″;
wherein each trapezoidal hollow clay-brick blocks is made of clay.

4. The set of glazed clay-brick blocks of claim 3, further comprising:
a parallelogram shaped hollow clay-brick block having non-perpendicular parallel sides with L×H×W dimension 23″×12″×23″.
